(19) United States
(12) Patent Application Publication
(10) Pub. No.: US 2025/0128958 A1
(43) Pub. Date: Apr. 24, 2025

(54) HYDROGEN TITANIUM OXIDE COMPOSTIONS AND METHODS FOR MAKING AND USING SAME

(71) Applicant: University of Louisiana at Lafayette, Lafayette, LA (US)

(72) Inventors: Daniel GANG, Lafayette, LA (US); Xiaobo LEI, Lafayette, LA (US); Mark E ZAPPI, Lafayette, LA (US); William E. HOLMES, Lafayette, LA (US); Mehdi MOKHTARI, Lafayette, LA (US); David SHOEMAKER, Lafayette, LA (US)

(73) Assignee: University of Louisiana at Lafayette, Lafayette, LA (US)

(21) Appl. No.: 18/924,609

(22) Filed: Oct. 23, 2024

Related U.S. Application Data
(60) Provisional application No. 63/592,329, filed on Oct. 23, 2023.

(51) Int. Cl. C01G 23/04; B82Y 30/00; C02F 1/28; C02F 101/10

(52) U.S. Cl. CPC C01G 23/04; B82Y 30/00; C02F 1/281; C01P 2004/64; C02F 2101/10; C02F 2305/08

(57) ABSTRACT

Disclosed herein are methods to make hydrogen titanium oxide (HₓTi_{y}O_{z}) compositions. The nano-HₓTi_{y}O_{z} can be used to remove pollutants and recover valuable materials. For example, the nano-HₓTi_{y}O_{z} can be used to isolate lithium from various aqueous mixtures, such as brines, seawater, oil gas-produced water, and lithium battery waste solutions.

### CROSS-REFERENCE TO RELATED APPLICATIONS

This application claims benefit of priority under 35 U.S.C. § 119 (e) of U.S. Ser. No. 63/592,329, filed Oct. 23, 2023, the entire contents of which is incorporated herein by reference in its entirety.

### BACKGROUND

### Technical Field

Provided herein are hydrogen titanium oxide compositions and methods for using them to adsorb and recover lithium from mixtures.

### Description of the Related Art

Due to the continuous depletion of fossil fuels, rapid industrialization, and adverse effects of climate change from carbon emissions, green energy electric vehicles (EVs) are developing fast and becoming more popular than traditional gasoline vehicles. EV sales are about 3.2 million in 2020 and are expected to increase by 10 million in 2025, 28 million in 2030, and 56 million in 2040. Lithium-ion batteries (LIBs) are currently the default choice in most EVs because of their high energy per unit mass relative to other electrical energy storage systems. Due to the growth in demand for EVs, the global requirement for lithium is approximately 0.5 million metric tons (MMT) of lithium carbonate equivalent (LCE) in 2021 and will rise to 2 MMT in 2025, and 3 MMT in 2030. However, lithium supply is far from the market needs due to the limitations in lithium extraction methods. EV industries are facing crucial lithium supply concerns that led to the rapid increase in lithium cost in recent years. Therefore, increasing the lithium supply was critical to meet future lithium demands given the forecasted EV industry growth and mitigating climate change by reducing carbon emissions.

In addition, oil and gas field brines, once considered a worthless by-product of production, were found have a contain lithium that could be extracted. Lithium is also a common element on the surface of the earth and is present in most water bodies, especially natural brines. According to statistics, 3% of the lithium exists in oilfield brines and 59% in natural brines. The lithium in these brines reaches several hundred parts per million (ppm) while few of these brine sources contain more than 1000 ppm. Hence, lithium extraction from brines is considered the most applicable method in lithium recovery due to its huge availability and high lithium concentrations.

Traditional lithium recovery is done via evaporation, but this method is causing a lot of environmental problems due to the high salts leaching into the surface water and groundwater. Aside from environmental pollution, the evaporation process is extremely slow which requires at least 12 months or even 24 months to get the final lithium product. This process is far behind the lithium market growth. To speed up lithium extraction from brines, new lithium recovery methods are being developed including precipitation, ion exchange, liquid-liquid extraction, and membrane process. However, the lithium-containing brines have an abundant number of cation impurities such as magnesium (Mg²⁺), calcium (Ca²⁺), sodium (Na⁺), and potassium (K⁺) which are significantly affecting the traditional lithium extraction process. For example, precipitating these impurities results in low purity of lithium precipitation product; the cation impurities can occupy the active sites on ion-exchange resin leading to low productivity; large amount of organic solvents in the liquid-liquid extraction process causes a massive threat to the environment; and frequent maintenance is required in the membrane process because of the blocking effect of these impurities. Thus, high selectivity, environmental, and cost-efficient extraction methods are preferred in future lithium recovery.

Currently, there are two main kinds of lithium-ion sieve to adsorb lithium ions from lithium-containing brines, mainly manganese (Mn) based oxides and titanium (Ti) based oxides. However, the loss of Mn from Mn-based oxides during acid treatment poses a serious problem that may cause water pollution in industrial operations. Compared with the Mn-based oxides, Ti-based oxides ion sieves are more chemically stable due to the stronger Ti—O bond and do not dissolve in acidic conditions. Therefore, Ti-based oxides ion sieves have been reported to have better lithium adsorption capacity and recyclability than that Mn-based oxides ion sieves.

Titanium is an earth-abundant element. Titanium compounds are deemed not harmful to the water environment since they can be easily removed from aqueous solutions. Hence, large amounts of titanium-based products are used in everyday life, including sunscreen, food, toothpaste, etc. Besides, titanium materials have been considered as emerging environment-friendly and effective products in wastewater treatment. Thus, titanium-based ion sieves have great potential in recovering lithium from brines in engineering applications.

The most used hydrogen titanium oxide (HTO) synthesis process is the solid-solid phase calcination method. Basically, two solid hydrogen titanium oxide precursors (anatase type TiO₂ and Li₂CO₃) are mixed by a ball mill (Li/Ti atom ratio=2) and heated in an alumina crucible at high temperature resulting in lithium titanium oxide (LTO), LiₓTi_{y}O_{z}, (Eq. 1), followed by acid treatment yielding hydrogen titanium oxide, HₓTi_{y}O_{z}, (Eq. 2), and finally used in lithium-ion (Li⁺) adsorption (Eq. 3).

Li₂CO₃+TiO₂→Li₂TiO₃+CO₂ (Eq. 1)

Li₂TiO₃+2HCl→H₂TiO₃+2LiCl (Eq. 2)

H₂TiO₃+2Li⁺→Li₂TiO₃+2H⁺ (Eq. 3)

Since solid-phase reaction occurs between solid and solid at the interface, this reaction has disadvantages such as slow reaction rate and slow substrate diffusion. Therefore, the above lithium titanium oxide preparation method (Eq. 1) always leads to poor homogeneous lithium titanium oxide. After acid washing (Eq. 2), only limited adsorption sites are generated (H/Ti<<2) that results in low lithium adsorption capacity (Eq. 3). Furthermore, due to the high temperature in the solid-phase reaction, the lithium titanium oxide crystal will stack together resulting in a large particle size (1-2 um) with less specific surface area and low pore volume. These traditional nonhomogeneous lithium titanium oxides with limited specific surface area cannot provide enough adsorption sites in the final hydrogen titanium oxide; hence, decreasing the lithium adsorption capacity. Moreover, the extremely narrow microporous (<2 nm) and limited pore volume in the final HTO require a long time for Li⁺ diffusion leading to slow adsorption kinetics.

Consequently, there is a need for new methods for making hydrogen titanium oxides that can provide small particle sizes, good surface area, and a large number of mesopores, allowing for the effective adsorption of contaminants.

### SUMMARY

Disclosed herein are methods for making and using nano-titanium oxides compositions. In a specific embodiment, a method of making nano-titanium oxides compositions includes: contacting TiO₂ and a lithium compound to make a LiₓTi_{y}O_{z}, where the TiO₂ has particle size from about 20 nm to about 150 nm, and where the LiₓTi_{y}O_{z} has particle size from about 20 nm to about 150 nm; and contacting the LiₓTi_{y}O_{z} and an acid to make HₓTi_{y}O_{z}, where the HₓTi_{y}O_{z} has a particle size from about 20 nm to about 150 nm.

In another specific embodiment, a method of making a nano-lithium titanium oxide includes: contacting anatase phase nano-TiO₂ and LiOH to make a hydrothermal nano-HₓTi_{y}O_{z}, where the hydrothermal nano-HₓTi_{y}O_{z} has particle size from about 20 nm to about 150 nm; and calcining the hydrothermal nano-HₓTi_{y}O_{z} to get a nano-lithium titanium oxide, where the nano-lithium titanium oxide has particle size from about 20 nm to about 150 nm.

In yet another specific embodiment, a method of using a hydrogen titanium oxide to remove a contaminant from an aqueous mixture includes contacting a hydrogen titanium oxide composition and an aqueous mixture containing a contaminant to at least partially reduce a concentration of the contaminant, where a hydrogen titanium oxide of the hydrogen titanium oxide composition has particle size from about 20 nm to about 150 nm.

### BRIEF DESCRIPTION OF THE DRAWINGS

For the purpose of promoting an understanding of the principles of the present disclosure, reference is now made to the embodiments illustrated in the drawings, which are described below. The embodiments disclosed herein are not intended to be exhaustive or limit the present disclosure to the precise form disclosed in the following detailed description. Rather, the embodiments are chosen and described so that others skilled in the art can utilize their teachings. Therefore, no limitation of the scope of the present disclosure is thereby intended.

FIG. 1 is an embodiment of a method for making nano-HₓTi_{y}O_{z}.

FIG. 2 is a schematic of an embodiment for fixed-bed column of nano-HₓTi_{y}O_{z} for lithium adsorption.

### DETAILED DESCRIPTION

It was surprising and unexpectedly discovered that a method for making hydrogen titanium oxide, HₓTi_{y}O_{z} (hydrogen titanium oxide, HTO), can reduce particle size, increase surface area, and increase the number of mesopores in the hydrogen titanium oxide, which can significantly improve contaminant adsorption capacity and increase contaminant adsorption rate. For example, the method for making a hydrogen titanium oxide can give hydrogen titanium oxide with an excellent ability for lithium adsorption, being much higher than the other Ti-based ion sieves. In another example, the method of making the hydrogen titanium oxide can give a hydrogen titanium oxide with a surface area increased from 24.45 m²/g to 39.78 m²/g with a large number of mesopores (2-50 nm) generated. Consequently, lithium adsorption capacity improved from 21.70 mg/g to 37.94 mg/g and the adsorption equilibrium time decreased from 25 hours to 5 hours.

In one or more embodiments, the method for making a titanium oxide can include, but is not limited to: contacting one or more titanium compounds and one or more lithium compounds to make one or more hydrogen titanium oxides. In another embodiment, the method for making a titanium oxide can include, but is not limited to: contacting one or more titanium compounds and one or more lithium compounds, one or more solvents or carrier fluids, one or more acids, one or more bases, one or more salts, and one or more additives, and to make one or more hydrogen titanium oxides. In another embodiment, the method for making a hydrogen titanium oxide can include a hydrothermal method in a liquid phase using anatase phase nano-TiO₂ and LiOH solution. For example, LiOH·H₂O can be dissolved in distilled water placed into an autoclave. Then, a nano-TiO₂ powder can be added with the temperature held at 180° C. for 6 h resulting in the hydrothermal nano-HₓTi_{y}O_{z}. The hydrothermal nano-HₓTi_{y}O_{z} can then be calcined at 700° C. for 2 h to get nano-lithium titanium oxide. Lastly, the calcined nano-lithium titanium oxide can be washed with a HCl solution and water with the final nano-HₓTi_{y}O_{z} obtained after drying at 50° C. for 12 h. The method for making a hydrogen titanium oxide can include one or more reaction mixtures. For example, the method for making a hydrogen titanium oxide can include a first reaction mixture, second reaction mixture, third reaction mixture, or more reaction mixtures. The method for making a hydrogen titanium oxide can make hydrogen titanium oxides that can be used in hydrogen titanium oxide compositions, which can be used as adsorbents. In an embodiment, the hydrogen titanium oxide compositions can be used in lithium recovery.

In another embodiment, the method for making a hydrogen titanium oxide can include a hydrothermal method in the liquid phase using anatase phase nano-TiO₂ and LiOH solution. For example, LiOH. H₂O can be dissolved distilled water into autoclave. Then, nano-TiO₂ powder can be added with the temperature held at 180° C. for 6 h resulting in the hydrothermal nano-HTO. The hydrothermal nano-HₓTi_{y}O_{z} can then be calcined at 700° C. for 2 h to get nano-lithium titanium oxide. Lastly, the calcined nano-lithium titanium oxide can be washed with HCl solution and water, and the final nano-HₓTi_{y}O_{z} was obtained after drying the remaining solid at 50° C. for 12 h.

The one or more hydrogen titanium oxides can include, but are not limited to: compounds of the formula HₓTi_{y}O_{z}, where x, y, and z can include an integer selected from 0, 1, 2, 3 or where x can include a real number from about 0.01 to about 6, y can include a real number from about 0.01 to about 5 and z can include a real number from about 0.01 to about 15.

The one or more hydrogen titanium oxides can include, but are not limited to: nano-sized particles, micro-sized particles, and mixtures thereof. For example, the hydrogen titanium oxides can have a diameter and/or length that varies widely. In another example, the titanium oxides particles can have a diameter and/or length from a low about 50 nm, about 60 nm, or about 80 nm, to a high of about 140 μm, about 150 μm, or about 200 μm. In another example, the titanium oxides can have a diameter and/or length from about 60 nm to about 60 microns, 50 nm to about 200 μm, about 50 nm to about 100 nm, about 60 nm to about 500 nm, about 60 nm to about 10 μm, about 65 nm to about 20 μm, about 70 nm to about 110 nm, about 75 nm to about 120 nm, about 80 nm to about 150 nm, about 80 nm to about 150 μm, about 80 nm to about 200 μm, or about 100 nm to about 180 μm.

The hydrogen titanium oxide can have mesopores with a length and/or radius that varies widely. For example, the hydrogen titanium oxide can have mesopores with a length and/or radius from a low of about 2 nm, about 5 nm, or about 10, to a high of about 40 nm, about 45 nm, or about 50 nm. In another example, the hydrogen titanium oxide can have mesopores with a length and/or radius from about 2 nm to about 50 nm, about 2 nm to about 50 nm, about 2 nm to about 50 nm, about 2 nm to about 50 nm, about 2 nm to about 50 nm, about 2 nm to about 50 nm, about 2 nm to about 50 nm, or about 2 nm to about 50 nm.

The hydrogen titanium oxide can have a surface area that varies widely. For example, hydrogen titanium oxide can a surface are from a low of about 15.00 m²/g, about 25.00 m²/g, about 15.00 m²/g, to a high of about 50.00 m²/g, about 75.00 m²/g, or about 100.00 m²/g. In another example, hydrogen titanium oxide can a surface are from about 15.00 m²/g to about 100.00 m²/g, about 24.45 m²/g to about 39.78 m²/g.

The one or more reaction mixtures can have a content of the one or more titanium compounds that varies widely. For example, the reaction mixtures can have a content of the one or more titanium compounds from a low of about 0.1 wt. %, about 1.0 wt. %, or about 5.0 wt. %, to a high of about 90.0 wt. %, about 95.0 wt. %, or about 99.9 wt. %. In another example, the reaction mixtures can have a content of the one or more titanium compounds from about 0.1 wt. % to about 99.9 wt. %, about 1.0 wt. % to about 99.0 wt. %, about 10.0 wt. % to about 90.0 wt. %, about 10.0 wt. % to about 20.0 wt. %, about 20.0 wt. % to about 30.0 wt. %, about 25.0 wt. % to about 75.0 wt. %, about 20.0 wt. % to about 80.0 wt. %, about 20.0 wt. % to about 30.0 wt. %, about 20.0 wt. % to about 60.0 wt. %, about 30.0 wt. % to about 40.0 wt. %, about 30.0 wt. % to about 70.0 wt. %, about 40.0 wt. % to about 60.0 wt. %, about 45.0 wt. % to about 55.0 wt. %, about 40.0 wt. % to about 50.0 wt. %, about 69.0 wt. % to about 75.0 wt. %, about 68.0 wt. % to about 82.0 wt. %, about 72.0 wt. % to about 86.0 wt. %, about 50.0 wt. % to about 73.0 wt. %, about 33.0 wt. % to about 48.0 wt. %, about 60.0 wt. % to about 70.0 wt. %, about 71.0 wt. % to about 81.0 wt. %, about 20.0 wt. % to 30.0 wt. %, about 50.0 wt. % to about 60.0 wt. %, or about 70.0 wt. % to about 80.0 wt. %. The weight percent of the one or more titanium compounds in the reaction mixtures can be based on the total weight of the reaction mixtures; or based on the total weight of the one or more titanium compounds, one or more lithium compounds, one or more solvents or carrier fluids, one or more acids, one or more bases, one or more salts, and one or more additives.

The one or more lithium compounds can include, but are not limited to: lithium carbonate, lithium hydroxide, compounds of the formula HₓLi_{y}O_{z}, where x, y, and z can include an integer selected from 0, 1, 2, 3 or where x can include a real number from about 0.01 to about 6, y can include a real number from about 0.01 to about 5 and z can include a real number from about 0.01 to about 15, and mixtures thereof.

The one or more reaction mixtures can have a content of the one or more lithium compounds that varies widely. For example, the reaction mixtures can have a content of the one or more lithium compounds from a low of about 0.1 wt. %, about 1.0 wt. %, or about 5.0 wt. %, to a high of about 90.0 wt. %, about 95.0 wt. %, or about 99.9 wt. %. In another example, the reaction mixtures can have a content of the one or more lithium compounds from about 0.1 wt. % to about 99.9 wt. %, about 1.0 wt. % to about 99.0 wt. %, about 10.0 wt. % to about 90.0 wt. %, about 10.0 wt. % to about 20.0 wt. %, about 20.0 wt. % to about 30.0 wt. %, about 25.0 wt. % to about 75.0wt. %, about 20.0 wt. % to about 80.0 wt. %, about 20.0 wt. % to about 30.0 wt. %, about 20.0 wt. % to about 60.0 wt. %, about 30.0 wt. % to about 40.0 wt. %, about 30.0 wt. % to about 70.0 wt. %, about 40.0 wt. % to about 60.0 wt. %, about 45.0 wt. % to about 55.0 wt. %, about 40.0 wt. % to about 50.0 wt. %, about 69.0 wt. % to about 75.0 wt. %, about 68.0 wt. % to about 82.0 wt. %, about 72.0 wt. % to about 86.0 wt. %, about 50.0 wt. % to about 73.0 wt. %, about 33.0 wt. % to about 48.0 wt. %, about 60.0 wt. % to about 70.0 wt. %, about 71.0 wt. % to about 81.0 wt. %, about 20.0 wt. % to 30.0 wt. %, about 50.0 wt. % to about 60.0 wt. %, or about 70.0 wt. % to about 80.0 wt. %. The weight percent of the one or more lithium compounds in the reaction mixtures can be based on the total weight of the reaction mixtures; or based on the total weight of the one or more titanium compounds, one or more lithium compounds, one or more solvents or carrier fluids, one or more acids, one or more bases, one or more salts, and one or more additives.

The one or more titanium compounds can be contacted with the one or more lithium compounds in a weight ratio that varies widely. For example, the weight ratio of the one or more titanium compounds to the one or more lithium compounds can be from about 0.2, about 0.5, about 0.7, about 1, about 2, about 3, about 4, about 5, about 6, about 7, about 8, about 9, about 10, about 11, about 12, about 13, about 14, or about 15. In another example, the weight ratio of the one or more titanium compounds to the one or more lithium compounds can be from about 0.2, about 0.5,about 0.7, about 1, about 2, about 3, about 4, about 5, about 6, about 7, about 8, about 9, about 10, about 11, about 12, about 13, about 14, or about 15.

The one or more lithium compounds can be contacted with the one or more titanium compounds in a weight ratio that varies widely. For example, the weight ratio of the one or more lithium compounds to the one or more titanium compounds can be from about 0.2, about 0.5, about 0.7, about 1, about 2, about 3, about 4, about 5, about 6, about 7, about 8, about 9, about 10, about 11, about 12, about 13, about 14, or about 15. In another example, the weight ratio of the one or more lithium compounds to the one or more titanium compounds can be from about 0.2, about 0.5,about 0.7, about 1, about 2, about 3, about 4, about 5, about 6, about 7, about 8, about 9, about 10, about 11, about 12, about 13, about 14, or about 15.

The one or more solvents and/or carrier fluids for the first reaction mixture, second reaction mixture, and catalyst mixture can include, but are not limited to: aliphatic hydrocarbons, such as hexanes; aromatic hydrocarbons, such as toluene and benzene; water; deionized water; methanol; ethanol; propanol; isopropanol; acetone; acetonitrile; chloroform; diethyl ether; methylene chloride; dimethyl formamide; ethylene glycol; propylene glycol; triethylamine; tetrahydrofuran; and mixtures thereof. The one or more reaction mixtures can have a content of the solvents and/or carrier fluids that varies widely. For example, the one or more reaction mixtures can have a content of the solvents and/or carrier fluids from a low of about 0.1 wt %, about 0.5 wt %, or about 1 wt %, to a high of about 50 wt %, about 70 wt %, or about 99.9 wt %. In another example, the one or more reaction mixtures can have content of the solvents and/or carrier fluids from about 0.1 wt % to about 99.9 wt %, 0.2 wt % to about 10 wt %, 0.5 wt % to about 10 wt %, about 2 wt % to about 20 wt %, about 5 wt % to about 60 wt %, about 15 wt % to about 25 wt %, about 17 wt % to about 54 wt %, about 19 wt % to about 27 wt %, about 15 wt % to about 27 wt %, about 14 wt % to about 24 wt %, about 11 wt % to about 28 wt %, about 33 wt % to about 48 wt %, about 51 wt % to about 54 wt %, or about 50 wt % to about 60 wt %. The weight percent of the content of the solvents and/or carrier fluids in the hydrogen titanium oxide compositions can based on the total weight of the hydrogen titanium oxide compositions, or based on the total weight of the one or more titanium compounds, one or more lithium compounds, one or more solvents or carrier fluids, one or more acids, one or more bases, one or more salts, and one or more additives.

The one or more acids can include, but are not limited to, hydrochloric acid, sulfuric acid, phosphoric acid, citric acid, nitric acid, humic acid, acetic acid, carbonic acid, formic acid, and combinations thereof. The one or more reaction mixtures can have a content of the one or more acids that varies widely. For example, the reaction mixtures can have a content of the one or more acids from a low of about 0.1 wt. %, about 1.0 wt. %, or about 5.0 wt. %, to a high of about 90.0 wt. %, about 95.0 wt. %, or about 99.9 wt. %. In another example, the reaction mixtures can have a content of the one or more acids from about 0.1 wt. % to about 99.9 wt. %, about 1.0 wt. % to about 99.0 wt. %, about 10.0 wt. % to about 90.0 wt. %, about 10.0 wt. % to about 20.0 wt. %, about 20.0 wt. % to about 30.0 wt. %, about 25.0 wt. % to about 75.0 wt. %, about 20.0 wt. % to about 80.0 wt. %, about 20.0 wt. % to about 30.0 wt. %, about 20.0 wt. % to about 60.0 wt. %, about 30.0 wt. % to about 40.0 wt. %, about 30.0 wt. % to about 70.0 wt. %, about 40.0 wt. % to about 60.0 wt. %, about 45.0 wt. % to about 55.0 wt. %, about 40.0 wt. % to about 50.0 wt. %, about 69.0 wt. % to about 75.0 wt. %, about 68.0 wt. % to about 82.0 wt. %, about 72.0 wt. % to about 86.0 wt. %, about 50.0 wt. % to about 73.0 wt. %, about 33.0 wt. % to about 48.0 wt. %, about 60.0 wt. % to about 70.0 wt. %, about 71.0 wt. % to about 81.0 wt. %, about 20.0 wt. % to 30.0 wt. %, about 50.0 wt. % to about 60.0 wt. %, or about 70.0 wt. % to about 80.0 wt. %. In another example, the one or more acids can include sulfuric acid and phosphoric acid in a ratio of about 12:1. about 10:1, about 9:1, about 8:1 about 7:1, or about 6:1. In another example, the reaction mixtures can be free of the one or more acids. The weight percent of the acid in the reaction mixtures can be based on the total weight of the reaction mixtures; or based on the total weight of the one or more titanium compounds, one or more lithium compounds, one or more solvents or carrier fluids, one or more acids, one or more bases, one or more salts, and one or more additives.

The one or more bases can include, but are not limited to, sodium hydroxide, calcium hydroxide, potassium hydroxide, sodium phosphate, and combinations thereof. The one or more reaction mixtures can have a content of the one or more bases that varies widely. For example, the reaction mixtures can have a content of the one or more bases from a low of about 0.1 wt. %, about 1.0 wt. %, or about 5.0 wt. %, to a high of about 90.0 wt. %, about 95.0 wt. %, or about 99.9 wt. %. In another example, the reaction mixtures can have a content of the one or more bases from about 0.1 wt. % to about 99.9 wt. %, about 1.0 wt. % to about 99.0 wt. %, about 10.0 wt. % to about 90.0 wt. %, about 10.0 wt. % to about 20.0 wt. %, about 20.0 wt. % to about 30.0 wt. %, about 25.0 wt. % to about 75.0 wt. %, about 20.0 wt. % to about 80.0 wt. %, about 20.0 wt. % to about 30.0 wt. %, about 20.0 wt. % to about 60.0 wt. %, about 30.0 wt. % to about 40.0 wt. %, about 30.0 wt. % to about 70.0 wt. %, about 40.0 wt. % to about 60.0 wt. %, about 45.0 wt. % to about 55.0 wt. %, about 40.0 wt. % to about 50.0 wt. %, about 69.0 wt. % to about 75.0 wt. %, about 68.0 wt. % to about 82.0 wt. %, about 72.0 wt. % to about 86.0 wt. %, about 50.0 wt. % to about 73.0 wt. %, about 33.0 wt. % to about 48.0 wt. %, about 60.0 wt. % to about 70.0 wt. %, about 71.0 wt. % to about 81.0 wt. %, about 20.0 wt. % to 30.0 wt. %, about 50.0 wt. % to about 60.0 wt. %, or about 70.0 wt. % to about 80.0 wt. %. In another example, the reaction mixtures can be free of the one or more bases. The weight percent of the base in the reaction mixtures can be based on the total weight of the reaction mixtures; or based on the total weight of the one or more titanium compounds, one or more lithium compounds, one or more solvents or carrier fluids, one or more acids, one or more bases, one or more salts, and one or more additives.

The pH of the one or more reaction mixtures can vary widely. For example, the one or more reaction mixtures can have a pH from about 4.0 to about 12.0, about 5.0 to about 10.0, about 7.5 to about 11.0, about 7.0 to about 10.0, about 8.0 to about 9.0, about 9.0 to about 10.0, about 8.0 to about 10.0, about 9.0 to about 11.0, or about 6.0 to about 9.0.

The one or more salts can include, but are not limited to: cesium formate, sodium chloride, sodium carbonate, sodium bicarbonate, potassium chloride, potassium carbonate, potassium bicarbonate, potassium fluoride, sodium fluoride, potassium formate, sodium formate, calcium chloride, ammonium carbonate, ammonium chloride, tetramethylammonium chloride, sodium chloride (NaCl), potassium chloride, and mixtures thereof. The one or more reaction mixtures can have a content of the one or more salts that varies widely. For example, the reaction mixtures can have a content of the one or more salts from a low of about 0.1 wt. %, about 1.0 wt. %, or about 5.0 wt. %, to a high of about 90.0 wt. %, about 95.0 wt. %, or about 99.9 wt. %. In another example, the reaction mixtures can have a content of the one or more salts from about 0.1 wt. % to about 99.9 wt. %, about 1.0 wt. % to about 99.0 wt. %, about 10.0 wt. % to about 90.0 wt. %, about 10.0 wt. % to about 20.0 wt. %, about 20.0 wt. % to about 30.0 wt. %, about 25.0 wt. % to about 75.0 wt. %, about 20.0 wt. % to about 80.0 wt. %, about 20.0 wt. % to about 30.0 wt. %, about 20.0 wt. % to about 60.0 wt. %, about 30.0 wt. % to about 40.0 wt. %, about 30.0 wt. % to about 70.0 wt. %, about 40.0 wt. % to about 60.0 wt. %, about 45.0 wt. % to about 55.0 wt. %, about 40.0 wt. % to about 50.0 wt. %, about 69.0 wt. % to about 75.0 wt. %, about 68.0 wt. % to about 82.0 wt. %, about 72.0 wt. % to about 86.0 wt. %, about 50.0 wt. % to about 73.0 wt. %, about 33.0 wt. % to about 48.0 wt. %, about 60.0 wt. % to about 70.0 wt. %, about 71.0 wt. % to about 81.0 wt. %, about 20.0 wt. % to 30.0 wt. %, about 50.0 wt. % to about 60.0 wt. %, or about 70.0 wt. % to about 80.0 wt. %. In another example, the reaction mixtures can be free of the one or more salts. The weight percent of the salts in the reaction mixtures can be based on the total weight of the reaction mixtures; or based on the total weight of the one or more titanium compounds, one or more lithium compounds, one or more solvents or carrier fluids, one or more acids, one or more bases, one or more salts, and one or more additives.

The one or more reaction mixtures can be heated to a temperature from a low of about 0° C., about 15°° C., and about 25°° C., to a high of about 35° C., about 65° C., and about 200°° C. For example, the one or more reaction mixtures can be heated to a temperature from about 25° C. to about 28° C., about 25° C. to about 35° C., about 25° C. to about 90° C., about 30° C. to about 45° C., about 45°° C. to about 55° C., about 40° C. to about 90° C., about 43° C. to about 78° C., about 40° C. to about 90° C., about 100° C. to about 200° C. In another example, the one or more reaction mixtures can be at room temperature. In another example, the reaction occurs at a temperature of greater than about 40° C. or greater than about 50° C. The first reaction mixture, second reaction mixture, third reaction mixture, and higher iterations and reaction mixtures can be performed at different temperatures.

The first reaction mixture, second reaction mixture, third reaction mixture, and more reaction mixtures can be reacted and/or stirred for a first reaction time, second reaction time, third reaction time, and higher iterations of reaction times from a short of about 15 s, about 120 s, or about 300 s, to a long of about 1 h, about 24 h, or about 72 h. For example, the first reaction mixture, second reaction mixture, third reaction mixture, and higher iterations of reaction mixtures can be reacted and/or stirred for a first reaction time, second reaction time, third reaction time, and higher iterations of reaction times can be from about 1 min to about 15 min, about 5 min to about 45 min, about 1 h to about 12 h, about 5 h to about 15 h, about 14 h to about 16 h, about 15 h to about 16 h, about 10 hours to about 24 hours, about 12 h to about 17 h, about 12 h to about 24 h, about 22 h to about 50 h, or about 24 h to about 72 h.

The one or more reaction mixtures can be calcined. For example, the one or more lithium compounds, the one or more titanium compounds, nano-TiO₂, LiOH, and/or hydrothermal nano-HₓTi_{y}O_{z} can be calcined to make the calcined nano-HₓTi_{y}O_{z} and/or calcined nano-lithium titanium oxide. For example, the one or more reaction mixtures can be calcined from a low of about 200° C., about 400° C., or about 500° C., to a high of about 700° C., about 1,000° C., or about 2,000° C.

In another example, the one or more reaction mixtures can be calcined from about 200° C. to about 2,000° C., about 600° C. to about 800° C., about 700° C. to about 1,000° C., or about 700° C. to about 2,000° C. In another example, the one or more reaction mixtures can be calcined from a short of about 1 min, about 30 min, or about 1 h, to a long of about 2 h, about 8 h, or about 48 h. In another example, the one or more reaction mixtures can be calcined from about 1 min to about 48 h, about 1 h to about 3 h, about 1 hour to about 8 h, or about 2 h to about 12 h.

The one or more reaction mixtures can be reacted and/or stirred in an open reaction container or a closed container. The one or more reaction mixtures can be reacted and/or stirred under a vacuum. The one or more reaction mixtures can be reacted and/or stirred under an inert atmosphere, such as He, Ne, N₂, and Ar.

The one or more reactions mixtures for making the hydrogen titanium oxide can have a viscosity that varies widely. For example, the one or more reactions mixtures can have a viscosity from a low of about 1 cP, about 10 cP, or about 1,000 cP, to a high of about 25,000 cP, about 90,000 cP, or about 250,000 cP. In another example, the reactions mixtures can have a viscosity from about 1 cP to about 250,000 cP, about 2 cP to about 100 cP, about 25 cP to about 2,500 cP, about 2,500 cP to about 200,000 cP, about 10,000 cP to about 100,000 cP, about 10,000 cP to about 50,000 cP, about 100,000 cP to about 250,000 cP, about 6000 cP to about 85,000 cP, about 7,000 cP to about 75,000 cP, about 7,000 cP to about 80,000 cP, about 5,000 cP to about 10,000 cP, or about 50,000 cP to about 200,000 cP. The viscosity of the reaction mixtures can be measured on a Brookfield viscosimeter. The viscosity of the reaction mixtures can be measured at various temperatures, such as 25° C., 40° C., 60° C., and 100° C.

In one or more embodiments, the method of using a hydrogen titanium oxide can include but is not limited to: contacting the one or more hydrogen titanium oxide compositions with a mixture containing one or more contaminants to reduce the concentration of the one or more contaminants in the aqueous mixture. The method of using a hydrogen titanium oxide can give selective lithium extraction, which is important because brines can contain a lot of impurities, such as K⁺, Ca²⁺, Mg²⁺, Ba²⁺, and Sr²⁺. In an embodiment, a method of using a hydrogen titanium oxide can include but is not limited to: incorporating hydrogen titanium oxide into ion-sieve oxides, which are adsorbents using specific template ions to create a unique space in their inner layer and these template ions that can be eluted from their crystal positions to form vacancy sites. During its application, the vacancy sites can be only re-occupied by its template-ion or smaller target ions and reject the ions which are larger than its template-ion. Therefore, the ion sieves can have a reliable screening and memory effect which can adsorb target ions from the coexistence of multiple ions. For the lithium-ion sieve (LIS), only lithium-ion (Li⁺) can enter the vacancy site and then replace the hydrogen ion (H⁺). Even though the radius of Mg²⁺ (0.072 nm) is smaller than Li⁺ (0.074 nm), the lithium-ion sieve still shows great lithium adsorption selectivity due to the low Gibbs free energy of hydration) (Δ_{hyd}G°) requirement for Li⁺. Moreover, the lithium-ion sieve does not require organic solvents in lithium extraction and frequent maintenance is not necessary to keep its long-term performance. As a result, the method of using a hydrogen titanium oxide lithium-ion sieves can ease the cost of operation and provide efficiency.

In one or more embodiments, the hydrogen titanium oxide composition can include, but are not limited to: one or more hydrogen titanium oxides, one or more solvents and/or carrier fluids, one or more acids, one or more bases, one or more salts, and one or more additives.

The one or more hydrogen titanium oxide compositions can have a content of the one or more hydrogen titanium oxides that varies widely. For example, the hydrogen titanium oxide composition can have a hydrogen titanium oxide content from a low of about 0.1 wt %, about 5 wt %, or about 30 wt %, to a high of about 70 wt %, about 80 wt %, or about 95 wt %. In another example, the hydrogen titanium oxide composition can have a hydrogen titanium oxide content of at least 15 wt %, at least 10 wt %, or at least 25 wt %. In another example, the hydrogen titanium oxide composition can have a hydrogen titanium oxide content from about 5 wt % to about 95 wt %, about 25 wt % to about 75 wt %, about 20 wt % to about 80 wt %, about 69 wt % to about 75 wt %, about 68 wt % to about 82 wt %, about 72 wt % to about 86 wt %, about 50 wt % to about 73 wt %, about 33 wt % to about 48 wt %, about 60 wt % to about 70 wt %, about 71 wt % to about 81 wt %, about 20 wt % to 30 wt %, about 50 wt % to about 60 wt %, or about 70 wt % to about 80 wt %. The weight percent of the hydrogen titanium oxide in the hydrogen titanium oxide composition can be based on the total weight of the hydrogen titanium oxide composition; or based on the total weight of the one or more titanium compounds, one or more lithium compounds, one or more solvents or carrier fluids, one or more acids, one or more bases, one or more salts, and one or more additives.

The one or more solvents and/or carrier fluids of the hydrogen titanium oxide compositions can include, but are not limited to: aliphatic hydrocarbons, such as hexanes; aromatic hydrocarbons, such as toluene and benzene; water; brines; seawater; oil and gas-produced water; lithium battery waste solutions; methanol; ethanol; propanol; isopropanol; acetone; acetonitrile; chloroform; diethyl ether; methylene chloride; dimethyl formamide; ethylene glycol; propylene glycol; triethylamine; tetrahydrofuran; and mixtures thereof.

The one or more hydrogen titanium oxide compositions can have a content of the solvents and/or carrier fluids that varies widely. For example, the hydrogen titanium oxide compositions can have a content of the solvents and/or carrier fluids from a low of about 0.1 wt %, about 0.5 wt %, or about 1 wt %, to a high of about 50 wt %, about 70 wt %, or about 99.9 wt %. In another example, the hydrogen titanium oxide compositions can have content of the solvents and/or carrier fluids from about 0.1 wt % to about 99.9 wt %, 0.2 wt % to about 10 wt %, 0.5 wt % to about 10 wt %, about 2 wt % to about 20 wt %, about 5 wt % to about 60 wt %, about 15 wt % to about 25 wt %, about 17 wt % to about 54 wt %, about 19 wt % to about 27 wt %, about 15 wt % to about 27 wt %, about 14 wt % to about 24 wt %, about 11 wt % to about 28 wt %, about 33 wt % to about 48 wt %, about 51 wt % to about 54 wt %, or about 50 wt % to about 60 wt %. The weight percent of the content of the solvents and/or carrier fluids in the hydrogen titanium oxide compositions can based on the total weight of the hydrogen titanium oxide compositions or based on the total weight of the one or more hydrogen titanium oxides, one or more solvents or carrier fluids, one or more acids, one or more bases, one or more salts, and one or more additives.

The one or more hydrogen titanium oxide compositions can have a content of the one or more additives that varies widely. For example, the hydrogen titanium oxide compositions can have a content of the one or more additives from a low of about 0.1 wt %, about 0.5 wt %, or about 1 wt %, to a high of about 50 wt %, about 70 wt %, or about 90 wt %. In another example, the hydrogen titanium oxide compositions can have content of the one or more additives from about 0.1 wt % to about 90 wt %, 0 wt % to about 10 wt %, 0.5 wt % to about 10 wt %, about 2 wt % to about 20 wt %, about 5 wt % to about 60 wt %, about 15 wt % to about 25 wt %, about 17 wt % to about 54 wt %, about 19 wt % to about 27 wt %, about 15 wt % to about 27 wt %, about 14 wt % to about 24 wt %, about 11 wt % to about 28 wt %, about 33 wt % to about 48 wt %, about 51 wt % to about 54 wt %, or about 50 wt % to about 60 wt %. The weight percent of the based on the total weight of the hydrogen titanium oxide composition or based on the total weight of the one or more hydrogen titanium oxides, one or more solvents or carrier fluids, one or more acids, one or more bases, one or more salts, and one or more additives. In some embodiments, the one or more additives can include, but is not limited to, one or more oxidizing agents, one or more reducing agent, and mixtures thereof. In some embodiments, the oxidizing agent can include, but are not limited to hydrogen peroxide, peroxone, trioxidane, ozone, Fenton's reagent, and mixtures thereof.

The one or more hydrogen titanium oxide compositions can have a viscosity that varies widely. For example, the hydrogen titanium oxide compositions can have a viscosity from a low of about 1 cP, about 10 cP, or about 1,000 cP, to a high of about 25,000 cP, about 90,000 cP, or about 250,000 cP. In another example, the hydrogen titanium oxide compositions can have a viscosity from about 1 cP to about 250,000 cP, about 2 cP to about 100 cP, about 25 cP to about 2,500 cP, about 2,500 cP to about 200,000 cP, about 10,000 cP to about 100,000 cP, about 10,000 cP to about 50,000 cP, about 100,000 cP to about 250,000 cP, about 6000 cP to about 85,000 cP, about 7,000 cP to about 75,000 cP, about 7,000 cP to about 80,000 cP, about 5,000 cP to about 10,000 cP, or about 50,000 cP to about 200,000 cP. The viscosity of the hydrogen titanium oxide compositions can be measured on a Brookfield viscosimeter. The viscosity of the hydrogen titanium oxide compositions can be measured at various temperatures, such as 25° C., 40° C., 60° C., and 100° C.

The one or more contaminants can include, but are not limited to: one or more lithium compounds, one or more lithium ions, and mixtures thereof. The concentration of the contaminant in the aqueous mixture can be reduced by the hydrogen titanium oxide composition from a low of about 1 wt %, about 2 wt %, or about 5 wt %, to a high of about 40 wt %, about 60 wt % or about 99 wt %. For example, the concentration of the contaminant in the aqueous mixture can be reduced by the hydrogen titanium oxide composition from about 1 wt % to about 99 wt %, about 1 wt % to about 10 wt %, about 2 wt % to about 20 wt %, about 5 wt % to about 30 wt %, about 10 wt % to about 60 wt %, about 15 wt % to about 85 wt %, about 35 wt % to about 95 wt %, about 45 wt % to about 55 wt %, or about 45 wt % to about 92 wt %.

The pH of the one or more hydrogen titanium oxide compositions can vary widely. For example, the one or more hydrogen titanium oxide compositions can have a pH from about 4.0 to about 12.0, about 5.0 to about 10.0, about 7.5 to about 11.0, about 7.0 to about 10.0, about 8.0 to about 9.0, about 9.0 to about 10.0, about 8.0 to about 10.0, about 9.0 to about 11.0, or about 6.0 to about 9.0.

The hydrogen titanium oxide composition can adsorb lithium in an amount that varies widely. For example, the hydrogen titanium oxide composition can adsorb lithium from a low about 15 mg/g, about 25 mg/g, or about 35 mg/g, to a high of about 100 mg/g, about 125 mg/g, or about 145 mg/g. In another example, the hydrogen titanium oxide composition can adsorb lithium from about 20 mg/g to about 40 mg/g, about 15 mg/g to about 142.9 mg/g, about 15 mg/g to about 40 mg/g, about 20 mg/g to about 45 mg/g, about 20 mg/g to about 30 mg/g, about 22 mg/g to about 60 mg/g, or about 25 mg/g to about 100 mg/g.

The hydrogen titanium oxide composition can have an adsorption rate for lithium that varies widely. For example, the hydrogen titanium oxide composition can have an adsorption rate for lithium from a short of about 15 s, about 120 s, or about 300 s, to a long of about 24 h, about 72 h, or about 5 days. In another example, the hydrogen titanium oxide composition can have an adsorption rate for lithium from about 1 min to about 15 min, about 5 min to about 45 min, about 1 h to about 12 h, about 5 h to about 15 h, about 7 h to about 9 h, about 8 h to about 16 h, about 9 h to about 16 h, about 10 hours to about 24 hours, about 12 h to about 17 h, about 12 h to about 24 h, about 22 h to about 50 h, or about 24 h to about 72 h.

### EXAMPLES

To provide a better understanding of the foregoing discussion, the following non-limiting examples are offered. Although the examples can be directed to specific embodiments, they are not to be viewed as limiting the invention in any specific respect.

It was found that the TiO₂ morphology can be improved by changing the Ti source and preparation method. Currently, the nano-template-supported sol-gel method is gaining interest due to its products showing a large specific surface area and plenty of mesopores. For example, nanotube TiO₂ (nano-TiO₂) was successfully synthesized from liquid Ti source Ti [OCH(CH₃)₂]₄ (TTIP) via sol-gel method with the support of nano-SiO₂ template produced from Si(OEt)₄ (TEOS). The resulting TiO₂ product showed a unique tube structure with an average outer tube diameter of 8 nm and an average length of 100 nm. After removing the SiO₂ inner filler, the nano-TiO₂ revealed a large specific surface area of 400 m²/g with an inner tube diameter of 5-6 nm. Thus, the merit of nano-TiO₂ is making it a potential precursor to fabricate the nano-HₓTi_{y}O_{z} to stimulate lithium adsorption performance.

Recently, the hydrothermal method has been applied in lithium titanium oxide (LTO) fabrication, anatase type solid TiO₂ and LiOH solution was used as the lithium source. The following is the reaction pathway:

TiO₂+2LiOH→Li₂TiO₃+H₂O (Eq. 4)

Compared with the traditional high-temperature solid phase reaction, the hydrothermal method does not require high temperatures and is relatively easier to operate (lower than 200° C.). The products generated from this process are more homogeneous with complete crystal form and uniform particle size. For example, the monoclinic cube lithium titanium oxide was successfully synthesized via the hydrothermal method with a Li/Ti atom ratio=1.99, the size of lithium titanium oxide was well maintained at 114 nm, and no block stack was observed in the hydrothermal product which suggests the feasibility of generating the homogeneous lithium titanium oxide crystal product through this method. Besides, only the change of the lithium titanium oxide crystal phase has been detected after the calcination of the hydrothermal lithium titanium oxide product. There was no obvious morphology growth taking place during post-high temperature treatments which indicates that the hydrothermal lithium titanium oxide has good structural thermal stability. Based on the previous studies, reducing the TiO₂ particle size can increase the final specific area of hydrogen titanium oxide and increase the hydrogen titanium oxide lithium adsorption capacity, creating the mesopores in hydrogen titanium oxide that can dramatically speed up the adsorption rate.

### Nano-TiO₂ Preparation Method 1:

Initially, 23.5 mL of concentrated Ti[OCH(CH₃)₂]₄ (TTIP) and 4.5 mL Si(OEt)₄ (TEOS) solution was added to 23 mL of EtOH and, then, was stirred for 15 min at room temperature. Subsequently, a mixture of 23 mL of EtOH and 18 g of 4.4 M HCl aqueous solution was slowly added to the previously mixed solution. The solution was kept for hydrolysis and gelled in an incubator at 40°° C. for 5 days. Afterward, the produced gel was heated at 500° C. for 2 h to get the anatase phase nano-TiO₂ and amorphous phase SiO₂ powder mixture. The powder mixture was placed in a polytetrafluoroethylene (PTFE) bottle with 20 mL of 10-20 M sodium hydroxide (NaOH) aqueous solution and was held at 60° C. for 20 h to remove the SiO₂. Lastly, the nano-TiO₂ was obtained by filtering out the resulting solid, washing the solid product with 1 L of deionized (DI) water followed by 100 mL of 0.1 M hydrochloric acid (HCl) solution, and 1 L of DI water again then dried.

### Nano-TiO₂ Preparation Method 2:

TiO₂ nanorods were synthesized by a hydrothermal method. TiO₂ (P25) powder is mainly used as a precursor. In the typical synthesis procedure, 50 ml of 10-20 M NaOH was stirred and 2 gm of TiO₂ powder was added to the solution. The mixture was stirred together for 10 minutes and transferred to the Teflon-lined stainless steel autoclave for hydrothermal treatment. The autoclave was kept in the oven at 150-200° C. for 15 h. Then, the autoclave allowed to the room temperature and wash the resulting solid with 0.05 M of HCl and distilled water, the remaining solid was dried.

### Nano-TiO₂ Preparation Method 3:

First, the titanium substrate was cleaned and polished to remove any impurities and to create a smooth surface. Then, the titanium substrate was immersed in an electrolyte solution containing a fluoride ion source (such as ammonium fluoride or hydrofluoric acid). Apply the electric field between the titanium substrate and a counter electrode to initiate anodization. The anodization time and voltage will determine the length and diameter of the nanotubes. The resulting TiO₂ nanotube was removed from the electrolyte solution, the solid product was rinsed with deionized water and dried.

### Nano-TiO₂ Preparation Method 4:

First, mix the titanium tetrachloride (TiCl₄) and hydrochloric acid (HCl) in deionized water to form a clear solution, and adjust the pH to 8-10. Then, transfer the precursor solution to a sealed Teflon-lined stainless-steel autoclave and heat it at a high temperature (typically 180-200° C.) for 5 hours. Then cool down autoclave to the room temperature and wash the resulting mixture with 0.05 M of HCl and distilled water, the remaining solid was dried.

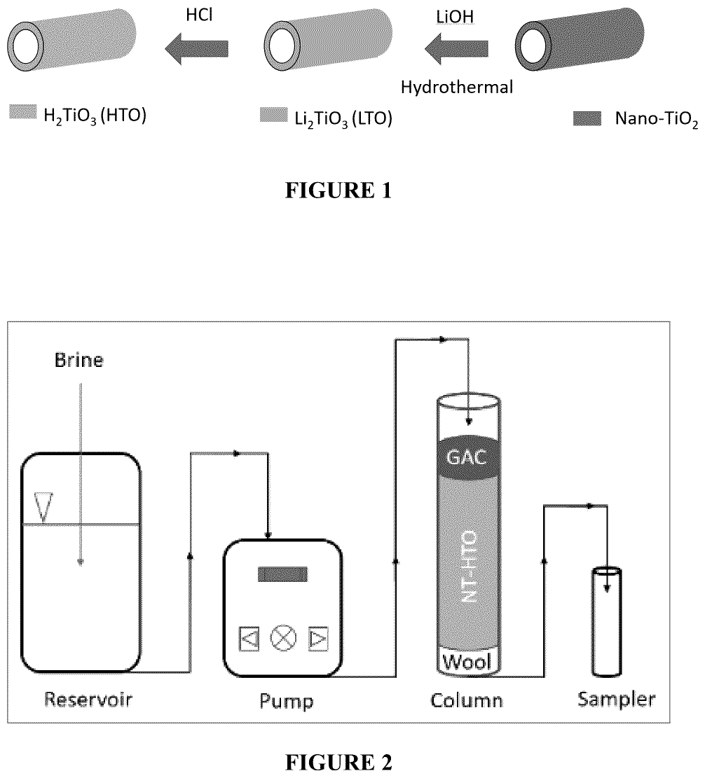

After the preparation of the precursor TiO₂, the nano-HₓTi_{y}O_{z} was prepared and synthesized via the hydrothermal method in the liquid phase using anatase phase nano-TiO₂ and LiOH solution. 1.259 g (0.03 mol) of LiOH·H₂O was dissolved into the Teflon lined autoclave (˜25 mL) together with 15 mL distilled water. About 1.198 g (0.015 mol) of nano-TiO₂ powder was added and held at 180° C. for 6 h resulting in the hydrothermal nano-HTO. Then, the hydrothermal nano-HₓTi_{y}O_{z} was calcined at 700° C. for 2 h to get nano-LTO. Lastly, the calcined nano-LTO was washed with 0.1 M HCl solution (1 g nano-LTO to 1 L HCl solution) and 1 L DI water, and the final nano-HₓTi_{y}O_{z} was obtained after drying the remaining solid at 50° C. for 12 h. The nano-HₓTi_{y}O_{z} synthesis procedure is illustrated in FIG. 1.

Preparation alternative: In TiO₂ parathion method 1, the size of nano SiO₂ can be enlarged to prevent the possible growth in the nano-HₓTi_{y}O_{z} inner tube during the hydrothermal treatment and further high-temperature calcination process. In this alternative method, the size of nano SiO₂ was precisely controlled by the alkoxy exchange equilibrium. In detail, the pure EtOH used above was replaced by ethanol and 1-propanol mixture (v/v=1:1). Introduction of 1-propanol might further increase the inner tube diameter and the specific surface area of nano-HₓTi_{y}O_{z} may be varied.

Adsorption capacity test experiments: Batch lithium adsorption experiments was conducted based on a variety of conditions. All adsorption experiments were carried out in 250-mL conical flasks mounted on a rotary shaker at 200 rpm to simulate a homogeneous system. One hundred fifty (150) milliliters of lithium solutions and 10 mg of nano-HₓTi_{y}O_{z} fabricated under different conditions was used in each test. One milliliter sample was taken from different conical flasks was filtered with 0.45 μm PTFE syringe filters and was analyzed with Inductively Coupled Plasma-Optical Emission Spectrometry (ICP-OES).

The lithium adsorption isotherms were carried out to investigate the maximum lithium adsorption capacity by nano-HTO. Different initial concentrations of lithium solution (5 mg/L, 10 mg/L, 20 mg/L, 50 mg/L, 100 mg/L, and 500 mg/L) was used in this isotherm study. Langmuir and Freundlich isotherm models were used to fit the experimental data.

Nano-HₓTi_{y}O_{z} optimization approach: Anatase phase nano-TiO₂ was generated in the calcination temperature range of 400-600° C., and different crystal phases (α, β, and γ) of the intermediate product nano-LTO was formed at varying temperatures (250-1150° C.). In the optimization step, the designed regression analysis method Response Surface Methodology (RSM) was used to reduce the number of experimental runs to produce the “best” designed nano-HₓTi_{y}O_{z} in terms of adsorption capacity. Central Composite Design (CCD) of the experiment was employed under RSM to determine the most suitable conditions for nano-HₓTi_{y}O_{z} preparation and synthesis to improve lithium recovery in terms of varying nano-TiO₂ calcination temperatures (X₁: 400-600° C.) and nano-LTO calcination temperatures (X₂: 250-1150° C.), with lithium adsorption capacity as the response.

The optimum conditions (calcination temperatures of nano-TiO₂ and nano-LTO) for adsorbent preparation and synthesis was determined through statistical analysis via analysis of variance (ANOVA). The response variables were fitted by a sufficient model which will describe the relationship between the dependent output variable and the independent variables using the regression method. Confirmatory experimental runs were performed to validate the results. These optimum conditions for the preparation of nano-HₓTi_{y}O_{z} adsorbent were used in adsorption experiments.

All adsorption experiments were carried out in 250-mL glass conical flasks mounted on a rotary shaker at 200 rpm to simulate a homogeneous system. The lithium adsorption kinetics was determined to evaluate how fast the nano-HₓTi_{y}O_{z} can adsorb the lithium. Lithium adsorptive capacity at varying times was obtained. Experimental data was fitted with pseudo-first-order (PFO), pseudo-second-order (PSO), Elovich, and Weber and Morris Intraparticle diffusion models.

The pH effects were studied in the pH range from 4 to 13. The adsorption thermodynamic study was assessed by evaluating the lithium adsorptive capacity under different temperatures (298 K, 318 K, and 333 K). Experimental data was used to calculate the Gibbs Free Energy of adsorption (ΔG°), Enthalpy change (ΔH°), and Entropy change (ΔS°) through the linear form of Van't Hoff equation. The required dosage was 5 mg, 10 mg, 20 mg, 50 mg, 100 mg, and 500 mg of nano-HₓTi_{y}O_{z} in each 100 mL lithium solution at different contractions (5 mg/L, 10 mg/L, 20 mg/L, 50 mg/L, 100 mg/L, and 500 mg/L).

Lithium desorption/regeneration experiments: All desorption experiments were carried out in 250-mL glass conical flasks mounted on a rotary shaker at 200 rpm to simulate a homogeneous system. The lithium desorption/regeneration kinetics was evaluated in 100 ml acid solutions (HCl, HNO₃, H₂SO₄) at different concentrations (0.01, 0.025, 0.05, 0.075, 0.1 M). After adding the spent nano-HₓTi_{y}O_{z} into each acid solution, different samples were taken after 0.5, 1, 2, 4, 8, and 12 h to test the lithium-ion concentrations. Once the desired lithium ion concentrations reached constant, the remaining solid was filtered out and dried in an oven at 50° C. for 8 h. After drying, the regenerated nano-HₓTi_{y}O_{z} was re-applied in lithium adsorption to evaluate the regeneration ability. In this desorption step, the stability of nano-HₓTi_{y}O_{z} can also be tested by determining the concentration of Ti⁴⁺ leachate in the desorption sample solutions. Based on the best lithium desorption and possible Ti⁴⁺ leachate results, the most suitable acid with its corresponding specific concentration was used in the future column study. After desorption, the regenerated nano-HₓTi_{y}O_{z} was tested with N₂ adsorption/desorption, TEM-SAED, and XRD to check its morphology stability.

Fixed-bed column adsorption experiments: The fixed-bed column studies was performed using a laboratory-scale glass column with an internal diameter of 1 inch and a length of 10 inches. Glass wool was put as support and the column was closed to ensure uniform liquid distribution. The column was packed with 8 inches of nano-HₓTi_{y}O_{z} to obtain a particular bed height for the lithium-ion adsorbent. Two inches of granular activated carbon (GAC) was added on top of the nano-HₓTi_{y}O_{z} adsorbent to remove the organic impurities from the real oil and gas-produced waste brines. The dynamic flow parameters in the nano-HₓTi_{y}O_{z} column were evaluated. In specific, the flow was controlled by a peristaltic pump with a flow rate of 5, 10, 15, and 20 mL/min; brines pH was adjusted at 7, 9, 11, 12, and 13; and the temperature was maintained at 15, 20, 25, and 30° C. Each effluent sample was collected at regular time intervals to determine the lithium concentration in the effluent solutions. The flow to the column will continue until there is no further lithium adsorption. The column adsorption performances: breakthrough appearance (tₐ, min) and the breakthrough curve, point of column exhaustion (tₑ, min), effluent volume (V_{eff}, mL), total mass of lithium adsorbed (m_{ads}, mg), maximum capacity of the column (m_{eq}, mg/g), total amount of lithium-ion entering column (mₜₒₜₐₗ, g), percentage of lithium recovery, and empty bed contact time (EBCT, min) was evaluated based on each column experiment. Adams-Bohart, Thomas, and Yoon-Nelson breakthrough models was developed to identify the best model for predicting the dynamic behavior of the column. FIG. 2 shows the fixed-bed column layout.

Fixed-bed column desorption experiments: Desorption studies was carried out after the adsorption experiments. The 2 inches GAC was removed first, then various acids (HCl, HNO₃, H₂SO₄) at different concentrations (0.01, 0.025, 0.05, 0.075, 0.1 M) was used as the washing reagents to evaluate the desorption performance. Each effluent sample was collected at regular time intervals to determine the lithium concentration in the effluent solutions. The elution efficiency of the process was calculated by integrating the elution curves. The column desorption performances: desorbed lithium mass (m_{d}, g), desorption efficiency (E, %), time of the desorption peak (tₚ, h), maximum desorption concentration (Cₚ, mg/L), and the overall concentration factor (CF) was assessed based on the desorption curve. Also, the leaching of Ti⁴⁺ ions was monitored to evaluate the stability of HT-HTO under different acid conditions.

Desorption alternatives: The organic impurities from real brines might be adsorbed on nano-HₓTi_{y}O₂ adsorbent which leads to the blocking effect. Therefore, to improve the desorption efficiency, the organic solvent (ethanol or isopropyl alcohol) should be applied first to remove the organic impurities on spent nano-HₓTi_{y}O_{z} followed by acid for lithium desorption.

One of ordinary skill in the art will readily appreciate that alternative but functionally equivalent components, materials, designs, and equipment can be used. The inclusion of additional elements can be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention. Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present invention is intended to embrace all such alternatives, modifications, and variations as fall within the scope of the claims, together with all equivalents thereof.

As used herein, the singular forms “a”, “an”, and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising”. As used herein, use of the term “including” as well as other forms, such as “includes,” and “included,” is not limiting.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. It should also be appreciated that the numerical limits can be the values from the examples. Certain lower limits, upper limits and ranges appear in at least one claims below. All numerical values are “about” or “approximately” the indicated value, and consider experimental error and variations that would be expected by a person having ordinary skill in the art.

It is understood that any specific order or hierarchy of steps in the processes disclosed is an illustration of example approaches. Based upon design preferences, it is understood that the specific order or hierarchy of steps in the processes can be rearranged, or that all illustrated steps be performed. Some of the steps can be performed simultaneously. For example, in certain circumstances, multitasking and parallel processing can be advantageous. Moreover, the separation of various system components illustrated above should not be understood as requiring such separation, and it should be understood that the described program components and systems can generally be integrated together in a single software product or packaged into multiple software products.

All patents, patent applications, provisional applications, and publications referred to or cited herein are incorporated by reference in their entirety, including all figures and tables, to the extent they are not inconsistent with the explicit teachings of this specification.

What is claimed is:

1. A method of making a nano-titanium oxides comprising:
contacting TiO₂ and a lithium compound to make a LiₓTi_{y}O_{z}, wherein the TiO₂ has particle size from about 20 nm to about 150 nm, and wherein the LiₓTi_{y}O_{z} has particle size from about 20 nm to about 150 nm; and
contacting the LiₓTi_{y}O_{z} and an acid to make HₓTi_{y}O_{z}, wherein the HₓTi_{y}O_{z} has particle size from about 20 nm to about 150 nm.

2. The method of claim 1, wherein the TiO₂ is contacted with the Li₂CO₃ in a weight ratio from about 1.0 to about 2.0.

3. The method of claim 1, wherein the lithium compound comprises LiOH.

4. The method of claim 1, wherein the lithium compound comprises Li₂CO₃.

5. The method of claim 1, wherein the acid comprises hydrochloric acid.

6. A method of making a nano-lithium titanium oxide comprising:
contacting anatase phase nano-TiO₂ and LiOH to make a hydrothermal nano-HₓTi_{y}O_{z}, wherein the hydrothermal nano-HₓTi_{y}O_{z} has particle size from about 20 nm to about 150 nm; and
calcining the hydrothermal nano-HₓTi_{y}O_{z} to get a nano-lithium titanium oxide, wherein the nano-lithium titanium oxide has particle size from about 20 nm to about 150 nm.

7. The method of claim 6, wherein the hydrothermal nano-HₓTi_{y}O_{z} is calcined at a temperature from about 4000° C. to about 800° C. for a reaction time of about 1.5 h to about 2.5 h.

8. A method of using a hydrogen titanium oxide composition to remove a contaminant from an aqueous mixture comprising:
contacting a hydrogen titanium oxide composition and an aqueous mixture containing a contaminant to at least partially reduce a concentration of the contaminant, wherein a hydrogen titanium oxide of the hydrogen titanium oxide composition has particle size from about 20 nm to about 150 nm.

9. The method of claim 8, wherein the contaminant comprises a lithium compound.

10. The method of claim 8, wherein the hydrogen titanium oxide composition further comprises an oxidizing agent, wherein the oxidizing agent is selected from hydrogen peroxide, peroxone, trioxidane, ozone, and Fenton's reagent.

11. The method of claim 8, wherein the aqueous mixture is selected from a list comprising: brine, seawater, oil and gas produced water, and lithium battery waste solutions.

12. The method of claim 11, wherein a concentration of a contaminant is reduced by about 45 wt % to about 55 wt %.
